(19) United States
(12) Patent Application Publication
(10) Pub. No.: US 2015/0354529 A1
(43) Pub. Date: Dec. 10, 2015

(54) Super Turbine for water wind and concentrated solar with accelerated flow

(71) Applicant: Kurt W. Henke, Folsom, CA (US)

(72) Inventor: Kurt W. Henke, Folsom, CA (US)

(21) Appl. No.: 14/504,734

(22) Filed: Oct. 2, 2014

Related U.S. Application Data
(60) Provisional application No. 61/997,578, filed on Jun. 5, 2014.

(51) Int. Cl. F03D 1/00

(52) U.S. Cl. CPC F03D 1/00

(57) ABSTRACT

My invention relates to turbines used in linear flowing current such as rivers, canals, any ocean current including tidal flow ebb and flood, wind and concentrated solar. It will Accelerate the incoming current when it arrives at the intake chamber with the intensifying flow guide and the second acceleration occurs when the current changes from the large rectangular opening to the smaller round opening of the turbine, and the third acceleration occurs when it flows through the openings in the transition plate and enter the vanes of the turbine. The openings in the transition plate can be of many different sizes to provide the desired ratio to get the accelerated flow speed for a suitable installation site where the existing flow rate is low. The openings in the transition plate extend to the outside wall of the turbine. A plurality of vanes, uniformly spaced around the turbine, and drive an alternator to produce electricity that will be charged in to the grid or to the locale power provider.

A super turbine 1 with a three stage accelerated flow, in a body of water, such as rivers, canals, any ocean current, wind and concentrated solar. It has an intensifying flow guide 2 inside the intake chamber 3 that has a large rectangular opening and than narrows toward the round opening of the turbine area thus accelerate and guide the flow toward the wall of the intake chamber 3 and up to the transition plate 4 where the flow accelerates again when it moves through four openings 5 which are of a predetermined size to provide many different ratios between the incoming flow at the intake chamber 3 and the accelerated flow. The four openings at the transition plate 4 extend toward the outside wall of the turbine and then enter a plurality of uniformly spaced vanes 6 around the turbine hub 7 and the outside wall which is turning with the turbine 7 until it exit's the turbine. The axle 8 and the turbine 7 is held in a bearing assembly 9 which is supported by the transition plate 4 in front and by the supporting plate 10 at the exit. At the exit the axle 8 has an up gear 11 that will turn a drive shaft 12 that is connected to and is driving the alternator 13 which will produce electricity that is charged in to the grid. There is a steel cable 14 to provide support for the intake chamber 3. A screen 16 for fish and birds when used with the wind and for debris. Small marine life that is passing through the rectangular openings of the screen will go for a safe ride through the turbine 7 and out the exit. The accelerated flow will not allow for any marine life to settle in the turbine 7. the opening of the rectangular intake chamber 3 will always be in a format where the lower part will align with the lower edge of the turbine 7 to prevent an upward flow and the upper part will always have a longer distance to the center line of the axle 8 to provide a higher volume of fluid where the weight of the fluid will push down the accelerated flow to enter the openings 5 in the transition plate and than in to the vanes 6 on the turbine 7. The upper part from the vanes 6 shall be bend slightly upward and the lower part shall be bend slightly downward, at the beginning and at the exit; for an easy entrance of the flow at the beginning and a diffused exit at the exit.

For a tidal flow, ebb and flood installation, another intake chamber 3 and another transition plate 4 needs to be installed at the exit end of the turbine 7. With the tidal flow the first vane must start on the right side from the center line of the axle 8 and end on the right side of the center line from the axle 8 when viewing it from each end of the turbine 7. The turbine hub 7 is sealed and provides enough space for the apparatus 1 to make controlled descent and ascent. 32 cubic feet are required for equilibrium. When the apparatus 1 arrives at the installation site and it starts its descent to the ocean floor, divers will guide it between the guide poles 17 and the storage slots 19, then secure the locking system 18 on each end of the cradle 15 and secure the locking slings 20 around the apparatus 1. The whole apparatus 1 is resting and be secured by the cradle 15 which is resting and secured by four pylons 16 that are driven in to the ocean floor and there is a concrete anchor on each end. In addition ballast is needed; using a steel net or bucket with rocks to keep it in place. To take advantage of the controlled descent and ascent the turbine hub 7 needs to be equipped with 2 inlets and two outlets with a shutoff control and the inlets will have a thread to connect a hose that leads to the surface and two pipes leading to the turbine hub 7. Divers will control the shutoff control to let water enter and exit the hub 7 and maintenance, above the surface, will attach a compressor to the hose to perform the descent and ascent of the apparatus 1.

I focused strongly on the environment and maintenance. The only two moving parts on the apparatus 1 is the turbine 7 and the alternator 13. Only two moving parts will make the apparatus 1 more efficient and cost effective.

### Description

A super turbine with a three stage accelerated flow, in a body of water, such as rivers, canals, any ocean current, wind and concentrated solar. It has an intensifying flow guide inside the intake chamber that has a large rectangular opening and than narrows toward the round opening of the turbine area thus accelerate and guide the flow toward the wall of the intake chamber and up to the transition plate where the flow accelerates again when it moves through four openings which are of a predetermined size to provide many different ratios between the incoming flow at the intake chamber and the accelerated flow. The four openings at the transition plate extend toward the outside wall of the turbine and then enter a plurality of uniformly spaced vanes around the turbine hub and the outside wall which is turning with the turbine until it exit's the turbine. The axle and the turbine is held in a bearing assembly which is supported by the transition plate in front and by the supporting plate at the exit. At the exit the axle has an up gear that will turn a drive shaft that is connected to and is driving the alternator which will produce electricity that is charged in to the grid. There is a steel cable to provide support for the intake chamber. A screen for fish and birds when used with the wind and for debris. Small marine life that is passing through the rectangular openings of the screen will go for a safe ride through the turbine and out the exit. The accelerated flow will not allow for any marine life to settle in the turbine. The opening of the rectangular intake chamber will always be in a format where the lower part will align with the lower edge of the turbine to prevent an upward flow and the upper part will always have a longer distance to the center line of the axle to provide a higher volume of fluid where the weight of the fluid will push down the accelerated flow to enter the openings in the transition plate and than in to the vanes on the turbine. The upper part from the vanes shall be bend slightly upward and the lower part shall be bend slightly downward, at the beginning and at the exit; for an easy entrance of the flow at the beginning and a diffused exit at the exit.

For a tidal flow, ebb and flood installation, another intake chamber and another transition plate needs to be installed at the exit end of the turbine. With the tidal flow the first vane must start on the right side from the center line of the axle and end on the right side of the center line from the axle when viewing it from each end of the turbine. The turbine hub is sealed and provides enough space for the apparatus to make controlled descent and ascent. 32 cubic feet are required for equilibrium. When the apparatus arrives at the installation site and it starts its descent to the ocean floor, divers will guide it between the guide poles and the storage slots, then secure the locking system on each end of the cradle and secure the locking slings around the apparatus. The whole apparatus is resting and be secured by the cradle which is resting and secured by four pylons that are driven in to the ocean floor and there is a concrete anchor on each end. In addition ballast is needed; using a steel net or bucket with rocks to keep it in place. To take advantage of the controlled descent and ascent the turbine hub needs to be equipped with 2 inlets and two outlets with a shutoff control and the inlets will have a thread to connect a hose that leads to the surface and two pipes leading to the turbine hub. Divers will control the shutoff control to let water enter and exit the hub and maintenance, above the surface, will attach a compressor to the hose to perform the descent and ascent of the turbine.

I focused strongly on the environment and maintenance. The only two moving parts on The apparatus is the turbine and the alternator. Only two moving parts will make the Apparatus more efficient and cost effective.

### BACKGROUND OF THE INVENTION

### Patents Documents

| | | |
|---|---|---|
| 8,480,361 | Brian E Tews | July 2013 |
| 8,487,459 | Eder at all | July 2013 |
| 8,587,139 | Gerber | November 2013 |
| 5,032,957 | Speer | July 1991 |
| 6,833,631 | Van Breems | December 3004 |
| 8,290,908 | Potter | April 2011 |
| 20120173882 | Peter J Sterling | |
| 20120124986 | Richard Carter | |

### REFERENCES

Venturi effect in fluid turbine

Hydro power Harvesting—Engineering.com

Videos of water turbine with accelerated flow—web

My provisional Patent application U.S. 61/997,578 which is teaching the art of my Invention

The invention with venturi such as U.S. Pat. No. 8,030,789 in particular, start out with a given size and then narrow the path and accelerate around the center line of the axle with little or no radius on the invention with the cone effect start with a large opening and then move the flow through to a smaller opening and the accelerated flow is around the center line of the axle with little or no radius.

in my invention I feature a three stage acceleration process. First stage: the flow will enter the intake chamber which at the beginning has an intensifying flow guide that accelerates the flow and moves it toward the outside wall of the intake chamber. Second stage: The path in the intake chamber narrows toward the smaller opening of the turbine and now gets the third acceleration when it moves through the four openings in the transition plate and the accelerated flow will now enter the vanes of the turbine. The openings in the transition plate extend toward the outside wall of the turbine, away from the center line of the turbine axle to gain a high radius for better performance.

### A SUMMARY OF MY INVENTION

I have designed and figured an 8 foot diameter super turbine for water, wind and concentrated solar 16 feet long, with a three stage acceleration process and has a rectangular intake chamber with an intensifying flow guide and used the accelerated flow method with a ratio to accelerate the intake flow of 8 f p s up to 46.8 f p s and came up with 20 megawatt. I have not established an efficiency rating but I used 57%. Now I took same turbine without the three stage acceleration process and used the same size intake chamber and I came up with 9.8 megawatt. That is a significant difference. My super turbine with a three stage acceleration [process is a next generation turbine. An apparatus with only 2 moving items makes it more reliable, lower maintenance, more cost effective, provide a higher efficiency rating and ultimately benefit the ratepayer at the locale energy provider.

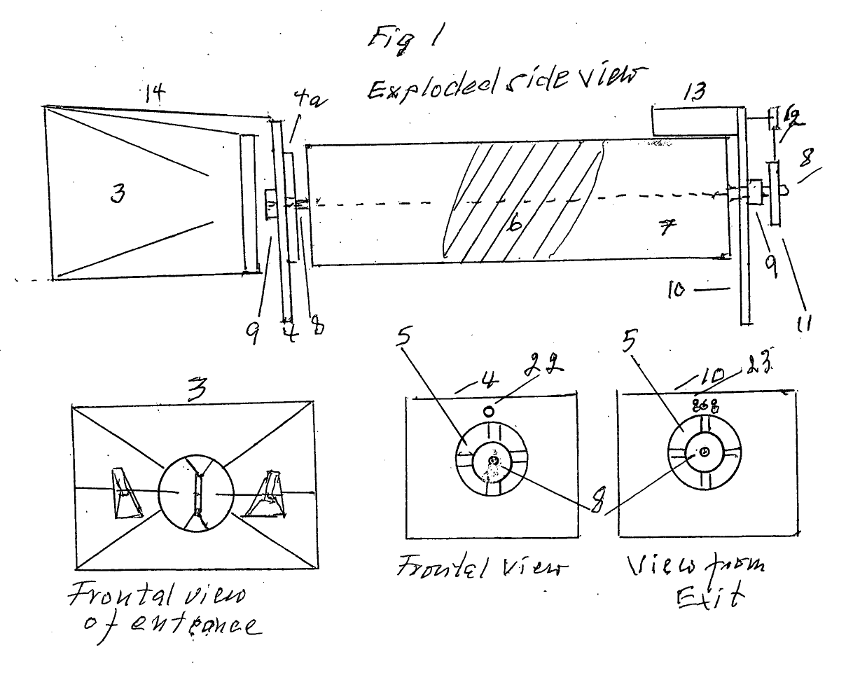

### EXPLANATION OF THE DRAWINGS

| | |
|---|---|
| Exploded view showing the whole apparatus | FIG. 1 page 1 of 2 |
| Frontal view of the transition plate | FIG. 1 page 1 of 2 |
| View of the exit | FIG. 1 page 1 of 2 |
| Top view of the cradle | FIG. 1 page 2 of 2 |
| Frontal view of screen for fish and bir4ds | FIG. 1 page 2 of 2 |

### Explanation of Parts and Figures

1 FIG. 1 Apparatus: Super turbine with three stage acceleration process.

2 FIG. 1 Intensifying flow guide is the first stage of the acceleration process.

3 FIG. 1 Rectangular intake chamber with an intensifying flow guide which is secured b the transition plate 4

4 FIG. 1 Transition plate which can have openings of different sizes for different Accelerated flow ratios and is supporting the intake chamber 3

4a FIG. 1 Sleeve mounted on the transition plate 4 four the turbine wall to turn Around.

5 FIG. 1 Openings to establish different ratios to accelerate the intake flow From the intake chamber to a desired accelerated flow rate.

6 FIG. 1 Vanes, uniformly spaced, moving around the turbine

7 FIG. 1 The hub where the vanes are located between the hub and the outer wall Of the turbine

8 FIG. 1 Axle of the turbine which is supported by the transition plate 4 and the turbine

9 FIG. 1 Bearing assembly supporting the turbine axle.

10 FIG. 1 Supporting plate at the exit to support the axle and the bearing assembly.

11 FIG. 1 Up gear for the alternator 13

12 FIG. 1 Drive shaft connecting with the alternator.

13 FIG. 1 Alternator will perform turning left or right.

14 FIG. 1 Steel cable to support the intake chamber that is secured by the transition Plate.

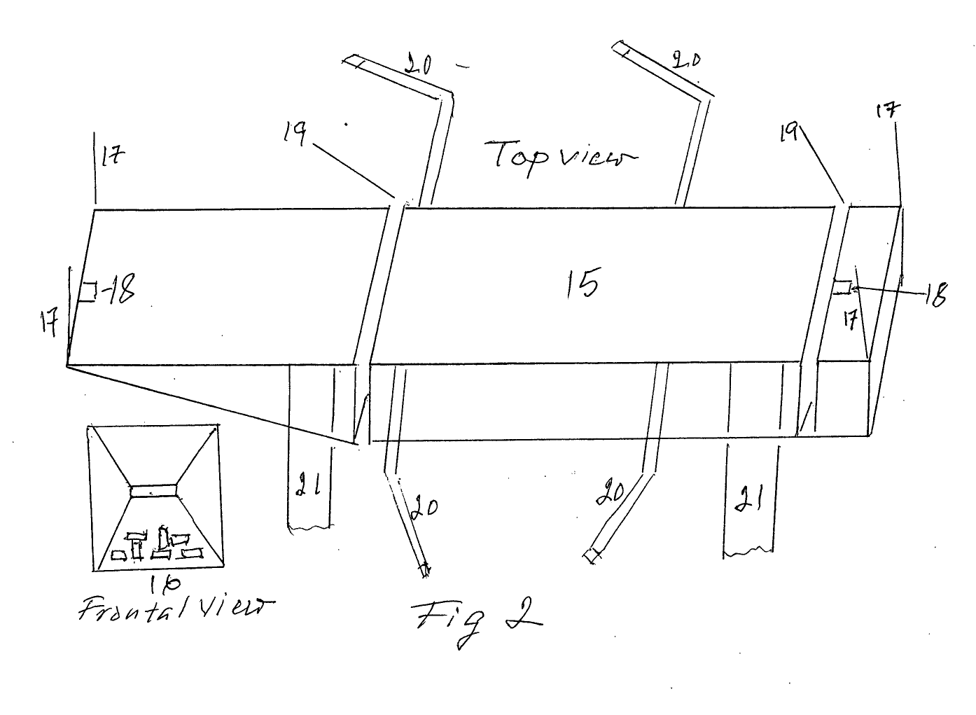

15 FIG. 2 Cradle on the ocean floor holding and securing the apparatus 1

16 FIG. 2 Screen for fish and birds with rectangular openings.

17 FIG. 2 Guide poles on the cradle to guide the apparatus 1

18 FIG. 2 Locking system to secure the apparatus 1

19 FIG. 2 Storage slots for apparatus 1

20 FIG. 2 Locking slings to secure apparatus 1

21 FIG. 2 Pylons for support of the cradle 15

22 FIG. 2 Bolt for steel cable 14

23 FIG. 2 Bolts and shaft for alternator 13

What I claim is:

1. An improved turbine in a body of water such as rivers canals any ocean current wind and concentrated solar and provides a three stage acceleration process at first water or wind will enter a rectangular intake chamber where the intensifying flow guide accelerates the flow and secondly the intake chamber narrows from the beginning to the turbine diameter area and thus accelerates the flow thirdly the accelerated incoming flow will Move through the four openings in the transition plate extend to the outside wall of the turbine where the desired accelerated flow will enter the vanes of the turbine.

2. an improved turbine as in claim 1 having a transition plate with four openings which extend to the outside diameter of the turbine wall and can be made in many different sizes to establish a ratio between the incoming water or wind to find a ratio required to accelerate the intake flow from the intake chamber through the transition plate for a desired accelerated flow to enter the vanes of the turbine.

3. an improved turbine as in claim 1 having a turbine with a plurality of vanes uniformly spaced and move around the turbine hub at approximately 60 degrees and the first vane starting on the right side on the center line of the axle and end on the right side of the center line of the axle viewing it from each end of the turbine so the turbine will function as a bidirectional turbine and where at the entry the upper part of the vane is bend slightly upward and the lower part is slightly bend downward for an easy entry of the accelerated Flow and to protect the micro marine life and bend the same way at the exit for a diffused exit of the accelerated flow.

4. an improved turbine as in claim 1 having vanes which are located between the turbine hub and the outside wall which is turning with the turbine to protect the environment.

5. an improved turbine as in claim 1 having a rectangular intake chamber where the bottom line of the intake chamber is in line with the outside diameter of the turbine and where the upper line will always have a longer distance to the center line of the axle than the lower line of the intake chamber and when the rectangular intake chamber with a three stage acceleration process is installed at the exit of the turbine it will diffuse the accelerated flow thus slowing it down reduce the backpressure increase the performance and the efficiency and depending on the installation site will prevent corrosion.

6. an improved turbine as in claim 1 having a screen for fish small debris and for birds when used in wind at the intake chamber where two sheets extend upstream and narrow the distance from side to side and meet at the center line of the turbine axle and two more sheets to fill in the sides so the flow of water and wind keep the screen clean and all four sheets of metal or whatever material is used will have rectangular openings not uniformly spaced on the screen that must provide at least 50% of the space from the intake chamber of a particular size super turbine diameter with accelerated flow for water wind and concentrated solar
